(19) United States
(12) Patent Application Publication
(10) Pub. No.: US 2019/0274324 A1
(43) Pub. Date: Sep. 12, 2019

(54) MANUFACTURING OF PLANT-BASED YOGURT

(71) Applicant: Califia Farms, LLC, Los Angeles, CA (US)

(72) Inventors: Geoffrey Margolis, Los Angeles, CA (US); Scott Myers, Los Angeles, CA (US); Dan Newbold, Los Angeles, CA (US)

(21) Appl. No.: 16/293,282

(22) Filed: Mar. 5, 2019

Related U.S. Application Data
(60) Provisional application No. 62/639,120, filed on Mar. 6, 2018.

(51) Int. Cl. A23C 11/10

(52) U.S. Cl. CPC A23C 11/106; A23Y 2220/29; A23Y 2240/75; A23V 2002/00; A23C 2240/15; A23V 2200/3204; A23V 2200/12; A23V 2250/548; A23V 2250/5116

(57) ABSTRACT

Described are processes of preparing plant milk-based yogurt and yogurt products. The process does not require the addition of lactase and thus makes production of lactose-free yogurt efficient and economic. Addition of a soluble fiber, in certain embodiments, can substantially reduce the fermentation time. Yogurt and yogurt products prepared by such processes are also described in the present disclosure.

### CROSS REFERENCE TO RELATED APPLICATIONS

This application claims the benefit under 35 U.S.C. § 119(e) of United States Provisional Application Ser. No. 62/639,120, filed Mar. 6, 2018, the content of which is incorporated by reference in its entirety into the present disclosure.

### BACKGROUND

Dairy products have been consumed by humans for many centuries and today's Americans, including some vegetarians, still consume substantial amounts of dairy products. The consumption of dairy products, however, is potentially associated with health concerns and risks. For example, dairy products contribute significant amounts of saturated fat to the diet. Diets high in fat and especially in saturated fat can increase the risk of heart disease and can cause other serious health problems. Consumption of dairy products has also been linked to higher risk for various cancers, especially to cancers of the reproductive system. Most significantly, dairy product consumption has been linked to increased risk for prostate and breast cancers.

A more acute risk from consumption of dairy products is lactose intolerance which affects approximately 95 percent of Asian-Americans, 74 percent of Native Americans, 70 percent of African-Americans, 53 percent of Mexican-Americans, and 15 percent of Caucasians. The symptoms of lactose intolerance include gastrointestinal distress, diarrhea, and flatulence. Individuals with lactose intolerance do not have the enzyme lactase to digest the milk sugar lactose. When digested, the breakdown products of lactose are two simple sugars: glucose and galactose.

Additionally, food allergies frequently appear to be a common result of cow's milk consumption, particularly in children. Cow's milk consumption has also been linked to chronic constipation in children.

Yogurt is an important milk-derived food product, made by bacterial fermentation of milk using yogurt cultures that contain at least the bacterial strains of S. thermophilus and L. bulgaricus.

These yogurt strains ferment and consume all or part of the 2%-8% lactose present in cows or other animal milks and produce lactic acid that gives traditional yogurt its texture and characteristics that provide the enjoyable taste. Further, in addition to the pleasant organoleptic characteristics of yogurt, traditional yogurts are also considered to provide consumers with certain health benefits including lower amounts of lactose (consumed in the fermentation) and elevated bacterial counts of the yogurt culture strains which, on consumption, are considered to provide probiotic positive effects.

Industrially, yogurts are generally made from homogenized and pasteurized milk that has been inoculated with a starter culture containing at least the S. thermophilus and L. bulgaricus yogurt strains. The inoculated mix is incubated at 40° C. to 45° C. for 4 to 6 hours until a pH of between 4.4 to 4.6 is reached, after which the yogurt is rapidly cooled and packaged either plain or with various added fruits and then sold through a cold chain distribution system.

Plant milks, on the other hand, have been consumed for centuries in various cultures, both as a regular drink and as a substitute for dairy milk. The most popular varieties are soy milk, almond milk, rice milk and coconut milk. Plant milks contain no lactose and thus do not cause lactose intolerance. The consumption of plant milk has been constantly rising in recent years for various reasons. Some of the more common reasons are ethical/animal welfare reasons, environmental reasons, and health reasons, in particular lactose intolerance.

As such, consumers have had a real interest in plant-based, yogurt like products that would provide them with the great flavor and texture of traditional (cows or other animal milk based) yogurts and the complete assurance that the yogurt does not contain any lactose but also provides additional health benefits such as probiotics.

In addition, today's consumers are seeking products that have minimal or no added sugar and are made from simple and natural ingredients so that the products have a so-called “clean label”.

Unfortunately, the absence of lactose or sugar which consumers are seeking in their plant-based yogurts presents real development and manufacturing problems, since traditional lactic acid yogurt strains generally require lactose for fermentation.

Further, the enjoyable ‘creamy-like” texture that consumers are seeking in the yogurt is partly due to the fat content of the milk and partly the result of the lactic acid (produced during the yogurt fermentation) interaction with casein and whey proteins present in cows' milk. Once again, due to the absence of these proteins in plant milks, creating these desired “creamy-like” textures in plant-based yogurt presents real challenges.

The few plant-based yogurts currently commercially available are generally deficient in texture and flavor when compared to yogurts made from cow's milk, and are frequently made from many ingredients including sugar.

Clearly, there is therefore a need for methods to economically produce plant-based yogurts using limited ingredients, that have the flavor and the texture of cow's or other animal milk based yogurts, and also provide substantially enhanced nutritional benefits to consumers.

### SUMMARY

The present disclosure describes processes of preparing plant milk-based yogurt or yogurt products. The process does not require the addition of lactose and thus makes production of lactose-free yogurt efficient and economic. Addition of a soluble fiber, in certain embodiments, can substantially reduce the fermentation time. Yogurt and yogurt products prepared by such processes are also described in the present disclosure.

In accordance with some embodiments of the present disclosure, provided is a method of preparing a food product, comprising fermenting a mixture comprising a plant milk, an effective amount of yogurt cultures, and an effective amount of soluble fiber. In some embodiments, the plant milk is prepared from either almond, coconut, cashew, macadamia nut, walnut, hazelnut, cereals, or a combination thereof. In some embodiments, the plant milk comprises almond milk or coconut milk, or the combination thereof. In some embodiments, the soluble fiber is obtained from oats, barley, rye, wheat, seaweed, or mushroom. In some embodiments, the soluble fiber comprises beta-glucans, such as beta-D-glucose polysaccharides.

In some embodiments, the effective amount of the soluble fiber is from about 0.05% (w/w) to about 3% (w/w) in the fermentation mixture. In some embodiments, the fermentation mixture comprises at least about 0.1% (w/w) beta-glucan. In some embodiments, the fermentation mixture does not include more than about 5% (w/w) glucose, sucrose or the combination thereof.

In some embodiments, the fermentation mixture further comprises plant proteins. In some embodiments, the fermentation mixture further comprises gums, pectin, starches or other plant based thickeners.

In some embodiments, the fermentation mixture does not include more than about 3% (w/w) of added lactose.

In some embodiments, the yogurt cultures comprise bacteria of the genus of Lactobacillus or Streptococcus. In some embodiments, the yogurt cultures comprise Lactobacillus delbrueckii or Streptococcus thermophiles.

In some embodiments, the fermentation mixture further comprises probiotic cultures. In some embodiments, the probiotic cultures comprise bacteria of the genus Bifidobacterium.

In another embodiment, provided is a method of preparing a food product, comprising fermenting a mixture comprising a plant milk, an effective amount of yogurt cultures and probiotic cultures, and an effective amount of soluble fiber. In some embodiments, the probiotic cultures comprise bacteria of the genus Bifidobacterium.

In some embodiments, the plant milk is prepared from either almond, coconut, cashew, macadamia nut, walnut, hazelnut, cereals, or a combination thereof. In some embodiments, the plant milk comprises almond milk or coconut milk, or the combination thereof. In some embodiments, the soluble fiber is obtained from oats, barley, rye, wheat, seaweed, or mushroom. In some embodiments, the soluble fiber comprises beta-glucans, such as beta-D-glucose polysaccharides.

In some embodiments, the food product is yogurt.

In some embodiments, the prepared yogurt contains less than about 0.1 g/L lactose.

Plant based yogurts prepared with the methods of the present disclosure are also provided, in various embodiments.

### DETAILED DESCRIPTION

It has been discovered, surprisingly and unexpectedly, that plant-based yogurt can be prepared by fermentation using lactic acid bacteria and yogurt strains (such as S. thermophilus and L. bulgaricus) or a combination of yogurt and probiotic strains in plant-based fermentable substrates. It is also discovered, surprisingly and unexpectedly, that plant-based yogurt can be prepared by fermentation without the addition of sucrose, glucose or lactose into a plant milk substrate that is naturally completely lacking in lactose.

Yet another surprising and unexpected discovery is that that the addition of a small amounts of soluble fiber to the plant-based fermentable substrate can substantially reduce fermentation times to reach a pH of 4.6 to around 4 hours, resulting in culturing times of plant-based milk yogurts that are similar to the culturing times of cow's or other animal milk-based yogurts. This reduction in fermentation times has additional major economic and processing advantages.

In accordance with some embodiments of the present disclosure, therefore, processes of preparing plant milk-based yogurt are provided, without addition (or with a small amount) of lactose. In accordance with some embodiments of the present disclosure, therefore, processes of preparing plant milk-based yogurt are provided, based on fermentation of the plant milk to which small amounts of soluble fiber have been added. Also provided, in some embodiments, are yogurt and yogurt products prepared by such processes.

In some embodiments, a yogurt production process of the present disclosure entails fermenting a plant milk admixed with an effective amount of a yogurt culture or a combination of yogurt and probiotic strains and an effective amount of soluble fiber to form a fermentation mixture (or simply “mixture”). In some embodiments, the present disclosure also provides yogurt prepared by the disclosed processes.

The term “plant milk” or “non-dairy milk” refers to a liquid that resembles dairy milk but includes its main ingredient from plant sources. Dairy milk is an emulsion of proteins, fats, vitamins, minerals, and sugars, especially lactose, in water. Dairy milk is an opaque white or bluish-white liquid secreted by the mammary glands of female mammal. Plant milk also contains proteins, fats, vitamins, minerals, and sugars in an emulsion but does not include lactose or cholesterol.

In one example, the plant milk is almond milk, which can be made by grinding almonds in a blender with water, then straining out the almond pulp with a strainer or cheesecloth. Almond milk can also be made by adding water to finely ground almonds, almond butter or cream.

In another example, the plant milk is coconut milk, which can be made by grating the white inner flesh of a brown coconut and mixing the shredded coconut meat with a small amount of water in order to suspend the fat present in the grated meat. The grating process can be carried out manually or by comminution, a process used to facilitate the grating.

The plant milk may also be a combination of one, two or more different types of plant-based milks produced from other plants sources such as cashew nuts, macadamia nuts, walnuts nuts, hazelnuts, cereals such as oats, coconuts, etc, mixed together.

It is a surprising discovery of the present disclosure that plant yogurt can be efficiently made with yogurt cultures or a combination of yogurt and probiotic strains fermenting plant milks to which has been added soluble oat fiber and without the involvement of lactose. In some embodiments, therefore, no lactose is present or added to the fermentation mixture during the process. In some embodiments, however, a relatively small amount of lactose may be present in or added to the fermentation mixture during the process, which can be readily consumed by the yogurt culture. In some embodiments, the amount of lactose present or added is less than about 3% (w/w), 2% (w/w), 1% (w/w), 0.9% (w/w), 0.8% (w/w), 0.7% (w/w), 0.6% (w/w), 0.5% (w/w), 0.4% (w/w), 0.3% (w/w), 0.2% (w/w), 0.1% (w/w), 0.09% (w/w), 0.08% (w/w), 0.07% (w/w), 0.06% (w/w), 0.05% (w/w), 0.04% (w/w), 0.03% (w/w), 0.02% (w/w), 0.01% (w/w), or 0.005% (w/w) of the fermentation mixture.

Soluble fibers largely consist of polysaccharide carbohydrates that can form a gel when mixed with a water containing liquid.

Oats/oat bran, dried beans and peas, nuts, barley, flaxseed, fruits such as oranges and apples, vegetables such as carrots and psyllium husks are good sources of soluble fiber.

The soluble fibers from oats, barley, rye, wheat, some types of seaweed, and various species of mushrooms contain larger amounts of beta-glucans,that consist of various molecular weight polymers of beta-D-glucose polysaccharides. Daily consumption of beta-glucans have potential positive health effects, particularly in reducing the risk of heart disease.

Soluble fibers are generally separated from the above-mentioned sources by mechanical and/or wet processing techniques that frequently include enzymatic digestion of longer chain polysaccharide carbohydrate molecules present in the source material. The enzymatic digestion serves to assist in the separation and concentration of the soluble fiber fractions including beta-glucans.

The amount of soluble fibers can vary in the fermentation mixture. In some embodiments, the fermentation mixture includes from about 0.05% (w/w) to about 3% (w/w) soluble fiber. In some embodiments, the fermentation mixture includes from about 0.1% (w/w) to about 2.5% (w/w) soluble fiber. In some embodiments, the fermentation mixture includes from about 0.2% (w/w) to about 1.5% (w/w) soluble fiber. In some embodiments, the fermentation mixture includes from about 0.3% (w/w) to about 1.2% (w/w) soluble fiber. In some embodiments, the fermentation mixture includes from about 0.4% (w/w) to about 1% (w/w) soluble fiber. In some embodiments, the fermentation mixture includes from about 0.5% (w/w) to about 0.9% (w/w) soluble fiber. In some embodiments, the fermentation mixture includes from about 0.6% (w/w) to about 0.8% (w/w) soluble fiber. In some embodiments, the fermentation mixture includes at least about 0.05%, 0.1%, 0.2%, 0.3%, 0.4%, 0.5%, 0.6%, 0.7%, 0.8% or 0.9% (w/w) soluble fiber. In some embodiments, the fermentation mixture includes no more than about 3%, 2.5%, 2%, 1.5%, 1.2%, 1.1%, 1%, 0.9%, 0.8%, 0.7%, 0.6%, 0.5%, 0.4%, 0.3%, 0.2% or 0.1% (w/w) soluble fiber.

Soluble fibers can consist of beta-glucan, maltodextrins and other carbohydrates, plant proteins, pectin, gums, inulin-type fructans and some hemicelluloses (e.g., arabinoxylan), among others.

Beta-glucan is a linear polysaccharide of glucose monomers with β(1,4) and β(1,3) linkages and found in the endosperm of cereal grains, primarily barley and oats. In some embodiment, the soluble fiber-containing fermentation mixture includes from about 0.01% (w/w) to about 2% (w/w) beta-glucan. In some embodiments, the soluble fiber-containing fermentation mixture includes from at least about 0.01%, 0.02%, 0.03%, 0.04%, 0.05%, 0.06%, 0.07%, 0.08%, 0.09%, 0.1%, 0.15%, 0.2%, 0.3%, 0.4%, or 0.5% (w/w) beta-glucan. In some embodiments, the soluble fiber-containing fermentation mixture includes no more than about 2%, 1%, 0.5%, 0.4%, 0.3%, 0.2%, 0.1%, 0.09%, 0.08%, 0.07%, 0.06%, 0.05%, 0.04%, 0.03%, or 0.02% (w/w) beta-glucan.

Maltodextrins and other carbohydrates and plant proteins also generally form part of commercially available soluble fibers and their content in the soluble fiber can be largely determined by the effectiveness of the separation and concentration processes used in the manufacture of the soluble fiber. In some embodiments, the soluble fiber used in the fermentation mixture can contain up to 10% plant protein, and 55% maltodextrins and other carbohydrates. In some embodiments, the soluble fiber used in the fermentation mixture can contain only 0.5% plant protein and less than 30% of maltodextrins and other carbohydrates.

In some embodiments, the soluble fiber-containing fermentation mixture includes from about 0.001% (w/w) to about 1% (w/w) plant proteins. In some embodiments, the soluble fiber-containing fermentation mixture includes from at least about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.15%, 0.2%, 0.3%, 0.4%, or 0.5% (w/w) plant proteins. In some embodiments, the soluble fiber-containing fermentation mixture includes no more than about 1%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% (w/w) plant proteins.

Inulin is a polymer of fructose monomers. In some embodiments, the soluble fiber-containing fermentation mixture includes from about 0.001% (w/w) to about 1% (w/w) inulin. In some embodiments, the soluble fiber-containing fermentation mixture includes from at least about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.15%, 0.2%, 0.3%, 0.4%, or 0.5% (w/w) inulin. In some embodiments, the soluble fiber-containing fermentation mixture includes no more than about 1%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% (w/w) inulin.

Consumers are increasingly demanding foods that contain higher quantities of proteins, as evidenced by the popularity of so called “Greek” style or strained yogurts that can contain up to around 10% protein. As such, in some embodiments, plant based proteins can be added to the plant based fermentation mixture to augment its protein content. The plant based proteins may constitute up to about 1%, 2%, 3%, 4%, 5%, 6%, 7%, 8%, 9%, 10%, 11%, 12%, 13%, 14% or 15% of the fermentation mixture. In some embodiments, the plant based proteins may constitute at least about 1%, 2%, 3%, 4%, 5%, 6%, 7%, 8%, 9%, or 10% of the fermentation mixture.

In other embodiments, responding to consumer desires, the thickness of the plant based yogurt can be adjusted by the addition to the fermentation mixture of gums, pectin, starches or other plant based thickeners.

In some embodiments, no glucose is present or added to the fermentation mixture during the process. In some embodiments, no sucrose is present or added to the fermentation mixture during the process. In some embodiments, no monosaccharide is present or added to the fermentation mixture during the process. In some embodiments, no disaccharide is present or added to the fermentation mixture during the process. In some embodiment, a relatively small amount e.g., less than about 5% (w/w), 4% (w/w), 3% (w/w), 2% (w/w), 1% (w/w), 0.9% (w/w), 0.8% (w/w), 0.7% (w/w), 0.6% (w/w), 0.5% (w/w), 0.4% (w/w), 0.3% (w/w), 0.2% (w/w), 0.1% (w/w), 0.09% (w/w), 0.08% (w/w), 0.07% (w/w), 0.06% (w/w), 0.05% (w/w), 0.04% (w/w), 0.03% (w/w), 0.02% (w/w), 0.01% (w/w), or 0.005% (w/w) in the fermentation mixture) of glucose, sucrose, any other monosaccharide, and/or any other disaccharide or carbohydrate may be present or added in the fermentation mixture for flavor enhancement reasons or to assist in the fermentation of the plant based substrate.

The term “yogurt culture” refers to any bacterium that is able to ferment lactose inside dairy milk to produce yogurt, or a composition that contains such a bacterium. Examples of yogurt cultures include, without limitation, bacterial genus Lactobacillus, such as species Lactobacillus delbrueckii. A subspecies commonly used for yogurt production is Lactobacillus delbrueckii subsp. bulgaricus. Another example is genus Streptococcus which includes species Streptococcus thermophiles. In some embodiments, the yogurt culture includes both Lactobacillus and Streptococcus. In some embodiments, the yogurt culture includes S. thermophilus and/or L. bulgaricus. In some embodiments, the yogurt culture includes only wild-type bacteria. In some embodiments, the yogurt culture is not genetically modified.

In some embodiments, the fermentation mixture further includes a probiotic culture. Probiotic cultures include live microorganisms intended to provide health benefits when consumed, generally by improving or restoring the gut flora. In some embodiments, the probiotic culture include a Bifidobacterium, is a probiotic strain. Living within the mucus lining of the large intestine and/or vaginal tract, Bifidobacterium bifidum prevents pathogenic bacteria and yeast from invading. Bifidum creates favorable changes in pH levels by producing lactic and acetic acids. In addition, this species increase absorption of iron, calcium, magnesium and zinc. Bifidobacterium infantis simulates the production of cytokines that affect the immune system, and can kill off such pathogens as clostrida, salmonella and shigella. Bifidobacterium longum colonizes the large intestine. It prevents unfriendly bacteria and yeast from taking residence. This can decrease the frequency of gastrointestinal problems, such as diarrhea, and nausea during antibiotic use.

As the process of some embodiments of the present disclosure does not include the addition or inclusion of lactose, the resulting yogurt necessarily does not include any lactose. In some embodiments, even when a small amount of lactose is added, the lactose will be completely removed in the final yogurt product.

The removal of lactose in this process is different from the conventional technology. In the conventional method, the lactose is relied upon by the bacteria as its main source of energy for metabolism and a sufficient amount of lactose is required to reach a pH of around 4.6. If the fermentation of lactose is incomplete, then there will be lactose remaining in the yogurt. On the other hand, if lactose is used up too early, the production of pH 4.6 yogurt is incomplete and this will impact the quality or flavor of the product. However, in certain embodiments of the present technology, which include added lactose, the bacteria need only to rely partially, on the limited added quantities of lactose for the fermented product to reach a pH of around 4.6, in order to produce a completely lactose free yogurt.

In some embodiments, no glucose, sucrose, other monosaccharides disaccharides or other carbohydrate are added (or already present) in the plant milk. Accordingly, the yogurt that is prepared with such a process has a lower sugar content than what is available in the art. Even when glucose is produced from breaking down the constituents of the plant milk, such as for example the soluble fiber it can be quickly fermented to produce lactic acid, ensuring low content of glucose, or other sugar, in the final product. In some embodiments, however, the yogurt of the present disclosure can include less than 100 g/L, or less than 90, 80, 70, 60, 50, 40, 30, 20, 10, 9, 8, 7, 6, 5, 4, 3, 2, 1, 0.9, 0.8, 0.7, 0.6, 0.5, 0.4, 0.3, 0.2, 0.1, 0.05, 0.02, or 0.01 g/L sucrose or glucose.

Food products derived from the yogurt and yogurt with additives (also referred to as “yogurt products”) are also provided, in some embodiments. Examples include, without limitation, fruit-flavored yogurt, salad with yogurt, and salad dressing.

### EXAMPLES

The following examples are included to demonstrate specific embodiments of the disclosure. It should be appreciated by those of skill in the art that the techniques disclosed in the examples which follow represent techniques to function well in the practice of the disclosure, and thus can be considered to constitute specific modes for its practice. However, those of skill in the art should, in light of the present disclosure, appreciate that many changes can be made in the specific embodiments which are disclosed and still obtain a like or similar result without departing from the spirit and scope of the disclosure.

### Example 1

Initial experiments were undertaken to assess the feasibility of producing a yogurt-like product using plant-based substrates and yogurt lactic acid bacteria. The tested plant-based substrates included almonds, soluble oat fibers, and coconut cream.

Each plant-based substrate was formulated with either 2.5% glucose or 5% sucrose to hopefully provide the yogurt lactic acid bacteria with an alternate carbon source to off-set the absence of lactose.

Table 1 below summarizes the general composition of four plant-based substrates that were prepared for culturing either by a culture mixture of S. thermophilus (ST)* and L. bulgaricus (LB) (LAB-1)* or a culture mixture of S. thermophilus (ST)**, L. bulgaricus (LB) ** and BB-12™** (LAB-2), a proprietary Bifidobacterium probiotic strain of Chr. Hansen (* and ** proprietary culture mixtures supplied by Chr. Hansen, Hoersholm, Denmark).

TABLE 1
Compositions of plant-based substrates for fermentation

| TEST | |
|---|---|
| No. | INGREDIENT COMPOSITION |
| 1-1 | Water, almond butter, pea protein, 2.5% glucose, soluble oat |
| | fiber, salt |
| 1-2 | Water, almond butter, pea protein, 5% sucrose, soluble oat fiber, |
| | salt |
| 1-3 | Water, almond butter, coconut cream, pea protein, 2.5% glucose, |
| | soluble oat fiber, salt |
| 1-4 | Water, almond butter, coconut cream, pea protein, 5% sucrose, |
| | soluble oat fiber, salt |

The ingredients of each test formula in Table 1 were well mixed, sterilized, homogenized and inoculated with 0.02% (w/w) of one or the other of the two above-mentioned culture mixes (LAB-1 or LAB-2). The fermentation was then carried out at a temperature of 105° F. for the length of time necessary for the cultured mass to reach a pH of 4.6.

Surprisingly, and completely unexpectedly, every formula and culture mix was able to produce a plant-based yogurt with a pH of 4.6 in about 4 hours—essentially the same culture time as found when using cow's milk!

In addition, all four plant-based yogurts had a nice and creamy texture.

### Example 2

In light of the unexpected and fast culture times discovered in Example 1, the cultured formulae (1-1 through 1-4) were sent to a commercial analytical laboratory to ascertain how much glucose or sucrose had been consumed during the fermentation. The results are summarized in Table 2.

Surprisingly, and unexpectedly, the results presented in Table 2 indicate that essentially no glucose nor sucrose was even consumed during the yogurt fermentation.

Further, the unexpected results of Table 2 suggest that the yogurt cultures were able to access a sufficient carbon supply for rapid metabolism from either one or a combination of almond butter, coconut cream and/or soluble oat fiber.

TABLE 2
Glucose and sucrose composition

| | | | | AFTER | |
|---|---|---|---|---|---|
| | | FORMULA | | CULTURING | |
| | | % | % | % | % |
| FORMULA | CULTURES | Glucose | Sucrose | Glucose | Sucrose |
| 1-1 | ST + LB | 2.50 | 0 | 2.33 | 0.13 |
| | ST + LB + | 2.5 | 0 | 2.36 | — |
| | BB-12 | | | | |
| 1-2 | ST + LB | 0 | 5.0 | 0.15 | 4.95 |
| | ST + LB + | 0 | 5.0 | — | 4.92 |
| | BB12 | | | | |
| 1-3 | ST + LB | 2.5 | 0 | 2.39 | 0.29 |
| | ST + LB + | 2.5 | 0 | 2.33 | 0.26 |
| | BB12 | | | | |
| 1-4 | ST + LB | 0 | 5.0 | — | 4.95 |
| | ST + LB + | 0 | 5.0 | 0.29 | 5.21 |
| | B12 | | | | |

Finally, the unexpected result that neither sucrose nor glucose is necessary for yogurt culture metabolism has major positive nutritional implications since it should now be possible to manufacture “sugar-free” plant-based yogurt.

### Example 3

In order to better understand how the plant-based formulae presented in Table 1 were able to be rapidly fermented by the yogurt cultures to a pH of 4.6 in around 4 hours, four simple 2 or 3 component formulae (see Table 3) were prepared according to the procedure described in Example 1. These 4 formulae were similarly cultured using culture LAB-2, and the time to reach a pH of 4.6 was noted and presented in Table 3.

TABLE 3
Culturing time comparison

| | | TIME TO |
|---|---|---|
| | | REACH |
| FORMULA | INGREDIENTS | pH 4.6 |
| 3-1 | Water 99.25%, soluble oat fiber 0.75% | 3 hours |
| 3-2 | Water 96.75%, soluble oat fiber 0.75% | 3 hours |
| | sucrose 2.5% | |
| 3-3 | Water 95%, almond butter 5% | 5 hours |
| 3-4 | Water 96%, coconut cream 4% | 5 hours |

Once again, surprising and unexpected results were obtained. First, the LAB-2 culture was able to ferment the soluble oat fiber an hour faster than normal yogurt fermentation times and the addition of sucrose (Trial 3-2) had no impact on the culture time, further confirming that sucrose is unnecessary for the yogurt fermentation to proceed.

Second, both almond butter and coconut cream can be fermented by LAB-2 cultures, although at a slower and less economical rate.

Clearly and unexpectedly, soluble oat fiber, whether sourced from oats or other sources, has a major and economically positive impact on reducing plant-based yogurt culture times necessary to reach a pH of 4.6.

Lactose, which is the main carbon energy source for yogurt lactic acid bacteria (LAB), is a disaccharide sugar derived from galactose and glucose which form a β-1,4-glycosidic linkage. Yogurt lactic acid bacteria secrete enzymes (such as beta-glucosidase) that hydrolyze the β-1,4-glycosidic linkage of lactose producing galactose and glucose which is subsequently metabolized by the LAB.

Plant-based milks, however, do not contain lactose and/or may not contain other sugars having the β-1,4-glycosidic linkage. It is therefore hypothesized that the LAB-secreted enzymes are also able to hydrolyze various other glucose linkages of carbohydrate molecules present in the soluble oat fiber, in almonds, in coconut cream or in other types of plant milks. Thus plant milks are also able to provide a rapid carbon energy source for fermentation.

In any event and for whatever the reason, the addition of soluble oat fiber in a plant-based yogurt substrate formula has a very positive impact on the speed to reach a pH of 4.6.

### Example 4

Unsweetened and sweetened plain plant-based yogurts were prepared incorporating the learnings of the prior examples.

Table 4 below summarized the composition of the plant-based substrate used to produce the yogurts.

TABLE 4
Composition of plant-based substrates used to product
yogurts

| | Unsweetened | Sweetened |
|---|---|---|
| | Substrate | Substrate |
| Ingredient | Formula | Formula |
| Water | 89.62% | 86.62% |
| Almond & Coconut Cream | 9.00% | 9.00% |
| Sugar | 0 | 3.00% |
| Soluble Oat Fiber | 0.75% | 0.75% |
| Gums (carob, acacia gellan) | 0.48% | 0.48% |
| Sea Salt | 0.15% | 0.15% |

As is standard practice with cow's milk yogurt, gums were included in the plant-based substrate formulae to prevent syneresis occurring during refrigerated storage. The unsweetened and sweetened substrates were processed according to the procedure described in Example 1 using the LAB-2 culture mixture at a 0.02% (w/w) inoculation level.

Both products reached a pH of 4.6 in 4 hours, and the plant-based yogurts were considered to have very enjoyable tastes and textures—similar to plain unsweetened and sweetened yogurts made from cow's milk. Finally, as indicated in Table 4, the unsweetened and sweetened plaint-based yogurts were made using a simple list of well-known ingredients which is highly desired by today's consumers.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A method of preparing a food product, comprising fermenting a mixture comprising a plant milk, an effective amount of yogurt cultures, and an effective amount of soluble fiber.

2. The method of claim 1, wherein the plant milk is prepared from either almond, coconut, cashew, macadamia nut, walnut, hazelnut, cereals, or a combination thereof.

3. The method of claim 1, wherein the plant milk comprises almond milk or coconut milk, or the combination thereof.

4. The method of claim 1, wherein the soluble fiber is obtained from oats, barley, rye, wheat, seaweed, or mushroom.

5. The method of claim 1, wherein the soluble fiber comprises beta-glucans.

6. The method of claim 5, wherein the soluble fiber comprises beta-D-glucose polysaccharides.

7. The method of claim 1, wherein the effective amount of the soluble fiber is from about 0.05% (w/w) to about 3% (w/w) in the fermentation mixture.

8. The method of claim 1, wherein the fermentation mixture comprises at least about 0.1% (w/w) beta-glucan.

9. The method of claim 1, wherein the fermentation mixture further comprises plant proteins.

10. The method of claim 1, wherein the fermentation mixture further comprises gums, pectin, starches or other plant based thickeners.

11. The method of claim 1, wherein the fermentation mixture does not include more than about 5% (w/w) glucose, sucrose or the combination thereof.

12. The method of claim 1, wherein the yogurt cultures comprise bacteria of the genus of Lactobacillus or Streptococcus.

13. The method of claim 1, wherein the yogurt cultures comprise Lactobacillus delbrueckii or Streptococcus thermophiles.

14. The method of claim 1, wherein the fermentation mixture further comprises probiotic cultures.

15. The method of claim 14, wherein the probiotic cultures comprise bacteria of the genus Bifidobacterium.

16. The method of claim 1, wherein the food product is yogurt.

17. The method of claim 16, wherein the prepared yogurt contains less than about 0.1 g/L lactose.

18. A method of preparing a food product, comprising fermenting a mixture comprising a plant milk, an effective amount of yogurt cultures and probiotic cultures, and an effective amount of soluble fiber.

19. The method of claim 18, wherein the probiotic cultures comprise bacteria of the genus Bifidobacterium.

20. The method of claim 18, wherein the plant milk is prepared from either almond, coconut, cashew, macadamia nut, walnut, hazelnut, cereals, or a combination thereof.
